(19) United States
(12) Patent Application Publication
(10) Pub. No.: US 2007/0185647 A1
(43) Pub. Date: Aug. 9, 2007

(54) Automated in-vehicle paging system

(76) Inventor: Gino Francis Nguegang, Macomb, MI (US)

Correspondence Address: GINO NGUEGANG, 21295 VENICE DRIVE, MACOMB, MI, 48044, US

(21) Appl. No.: 11/349,601

(22) Filed: Feb. 9, 2006

(51) Int. Cl. G01C 21/26

(52) U.S. Cl. 701/204; 340/994

(57) ABSTRACT

The present disclosure provides a description of an automated notification system based upon location apparatus and networks like the Global Positioning System (GPS) or land-based radio signal triangulation. Notifications are broadcasted to various devices based upon the position of the moving broadcasting unit. Signals from the broadcasting unit could be sent at preprogrammed time to corresponding receivers. The broadcasting unit has an onboard computer that is preprogrammed with route information including scheduled stops and wirelessly sends information at preprogrammed time to multiple receivers. The onboard computer receives live update route information from the control center wireless communication module that can override the information previously entered into the computer with a removable media.

### CROSS REFERENCE TO RELATED APPLICATIONS

The invention is a continuation of the provisional Patent Application No. 60/528,108 now abandoned.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The invention relates to an automated paging system that sends information to various devices based on preprogrammed request or live information.

One of the main focuses of the invention is to provide notification to wireless or fixed receivers based on preprogrammed information.

One application of the invention is, for example, in transportation services. A school bus could be equipped with the broadcast module, and the students who ride the bus given paging devices. The students will preprogram when they want to be paged based on the time they need to walk or drive to the pickup location. It will be useful in the wintertime because the students will spend less time in the cold weather waiting for the bus. The system could also be used as a notification mean for a parent in charge of picking up his or her child at the bus drop off location.

Another application could be delivery services, which can use the system to reduce the time spent at each stop. Customers will be given paging devices and a page will be sent if there is a delivery for them. Delivery services could give a discount to their customers if they agreed to speed up the receiving of goods. One way of doing this is to have someone ready to take possession of goods before the delivery truck arrival. In urban cities, for example, a customer in a high-rise building could go down to the first floor to take possession of goods without wasting the driver or delivery employee's valuable time.

The system could function as well with normal landline or mobile phones. The broadcast module will call the registered phone and issue the notification either as a voice or text message.

2. Description of the Prior Art

There are systems which provide time of arrival of various vehicles such as trains in train station or more recently taxicabs that can broadcast their estimated time of arrival to wireless devices. Some other devices are just locator/proximity sensor. For example, U.S. Pat. Nos. 5,557,259; 5,646,593; 5,689,240; 6,262,660 are illustrations of such devices. They provide a way to alert a base station when a remote sensor is in close proximity.

However none of the existing systems provide the automated broadcasting of information to multiples devices based on user request, route forecasting and preprogrammed or live information as in the present disclosure.

### SUMMARY OF THE INVENTION

The present invention provides an in-vehicle automated paging system comprised of a global positioning or radio receiver for receiving the vehicle location, a computer for managing the automated broadcasting of information, a wireless modem for receiving live information to update the vehicle computer database, an in-vehicle broadcast module for sending information, and multiple receivers for receiving notifications at preprogrammed timing.

### BRIEF DESCRIPTION OF THE DRAWINGS

To better understand the invention, the following drawings are described below:

FIG. 1 is a general system overview showing some of the main components of the present invention and the normal flow of instructions/information in the system.

FIG. 2 is an overview of the in-vehicle broadcast module with the information flow among its main components.

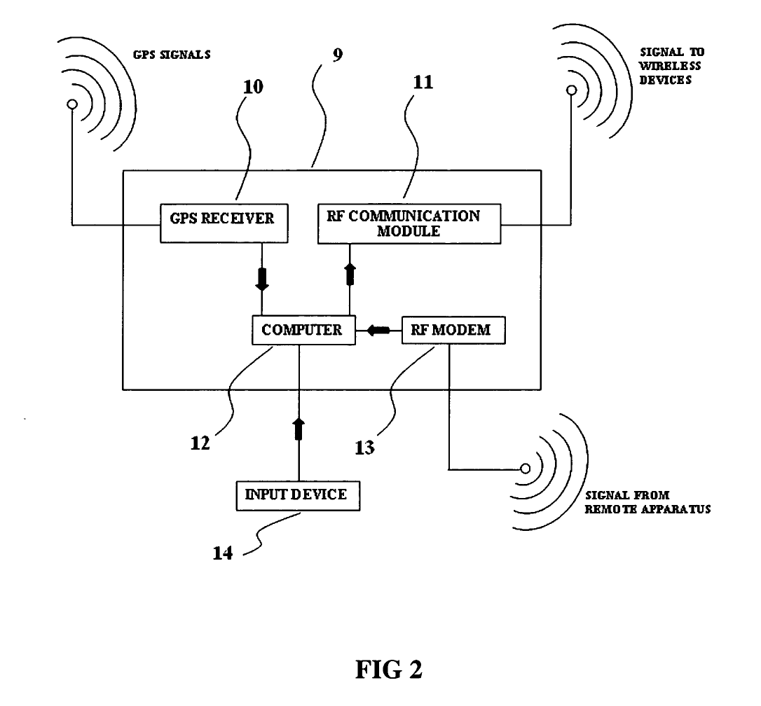

### DETAILED DESCRIPTION OF THE INVENTION

A detailed explanation will be given of embodiments of the invention in reference to the attached drawings.

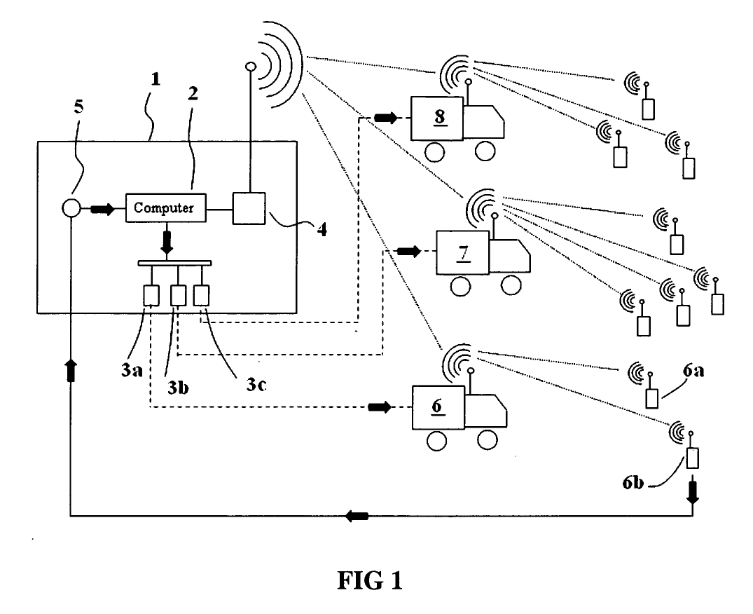

As shown in FIG. 1, one exemplary embodiment of the invention is herein described. The automated in-vehicle paging system is comprised of various modules.

The first module is the administration center 1 which hosts various devices. A simplified configuration of the administration center comprises a remote data entry device 5 which could be, for example, a phone data entry system, an internet connection or other means to remotely connect to the administration center computer 2. The computer 2 is used to log in remote users' entries which can be stored to a removable medium 3a, 3b, and/or 3c or sent wirelessly to vehicle 6, 7, and/or 8.

The second module is comprised of the vehicle fleet with an on-board communication system. Before vehicles 6, 7, and/or 8 or any vehicles affiliated with the system leave the administration center 1, the vehicles' route information which has been programmed from scheduled stop locations is transferred to the removable medium 3a, 3b, and/or 3c and to the corresponding vehicles which are in the illustration 6, 7, and/or 8. It should be noted that the system is not limited to the three vehicles depicted in the illustration and can comprise as many vehicles as required. Route stops are compiled from users' entries via remote data entry device 5 and predefined route information which could be, for example, school bus or delivery vehicle stops. Wireless connecting device 4 enables a live update of the route to the corresponding vehicles. Each vehicle has a unique identification number that will be a part of the radio signal emitted from the wireless communication module 9.

The third module is comprised of remote users with wireless receivers. A remote user 6b, for example, can request a “stop” or “no” stop of the corresponding vehicle 6 via its wireless radio modem 13. The system is useful in allowing the vehicle to make an unscheduled stop or preventing the vehicle from making an unnecessary stop at the user's request.

The vehicles affiliated with the system are all equipped with a wireless communication module 9. Before the route is started, removable media 3a for example is inserted into input device 14 of vehicle 6. The route information will hold street maps, locations of all stops, distances between stops, and all necessary information needed to manage the paging system as entered into the vehicle computer 12. While vehicle 6 is moving, it receives location coordinated from GPS receiver 10 that is then analyzed by computer 12. The computer program will calculate the estimated time of arrival to each route stops based on the vehicle's location and speed. Based on the next stop information stored in the route database, the computer will send a paging notification via the RF communication module 11 to the device 6a which has been tagged from the route information to receive the notification. The wireless communication module 9 could be comprised of multiple networked computers, multiple wireless radio modems, and multiple RF communication modules in order to handle a large volume of paging requests. One embodiment of the invention is the use of the preprogrammed route information for paging requests. Multiple radio devices located at the same distance from the radio source will receive the radio signal at the same time. To avoid paging multiple devices at the same time, the route information allows the system to intelligently page the corresponding device based on the computer knowledge of the next stop. Device 6a will receive a page at a preprogrammed time based on the vehicle location. The paging device 6a could be a one-way or two-way radio receiver, a computer connected to a phone line or the internet, or a landline phone. The one-way receiver will only receive and display the information sent by the wireless communication module 9. The two-way receiver will have all the function of the one-way receiver plus the ability to send queries to the communication module 9 or the administration center 1. The paging device has a display screen and input buttons for programming functions. The user will select, for example, the time delay from receiving a page from the in-vehicle communication module before the vehicle gets to a preprogrammed location. That time delay information is sent to the administration center 1 which will update the corresponding vehicle route information database. The paging device, after receiving the information pertaining to a vehicle identification number, will notify the user of the estimated time of arrival of the vehicle at the preprogrammed location. After the notification has been issued, the estimated time of arrival will be updated and displayed at set intervals based on the vehicle speed to allow for traffic conditions.

While only a preferred embodiment of the invention has been specifically herein described, it will be apparent to those skilled in the art that various omissions, changes, substitutions can be made to the notification system without departing in any way from the spirit of the present invention.

What is claimed is:

1- A notification system for sending relevant information to multiple wired or wireless devices comprising of the following modules:
(a) an administration center which manages the notification system by collecting users' requests, preparing route information for storage in removable medium or live update to fleet vehicles;
(b) wireless communication modules which receive route information from removable media or live update and send notifications to multiple devices;
(c) a fleet of vehicles from which locations are computed from received radio signals for sending preprogrammed or live notifications via a wireless communication module to wired or wireless devices in which the preliminary route information with all stops and time to send notifications have been stored in removable medium that are loaded onto the vehicle wireless communication modules;
(d) a multitude of notification devices for receiving notifications at a preprogrammed or random time wherein said notification devices have a display screen, light indicators, motion or sound means of alerting the users of the notification.

2- The notification system of claim 1, wherein said notification devices have input functions and wired or wireless means of connecting to the said administration center or fleet of vehicles for requesting, canceling or rescheduling a stop.

3- The notification system of claim 1, wherein said notification devices have display means for receiving updated information from said fleet of vehicles or said administration center.

4- The notification system of claim 1, wherein notification signals are received at said notification devices at a preprogrammed time.

5- The notification system of claim 1, wherein said notification device is a mobile phone.

6- The notification system of claim 1, wherein said notification device is a landline phone.

7- The notification system of claim 1, wherein said notification device is a pager.

8- The notification system of claim 1, wherein said notification device is a personal computer.

9- The notification system of claim 1, wherein said notification device is an electronic sign display.

10- The notification system of claim 1, wherein said fleet of vehicles have multiple on-board said wireless communication modules.
